(19) United States
(12) Patent Application Publication
(10) Pub. No.: US 2024/0143979 A1
(43) Pub. Date: May 2, 2024

(54) SYSTEM AND METHOD FOR GENERATING SYNTHETIC DATA WITH DOMAIN ADAPTABLE FEATURES

(71) Applicant: Tata Consultancy Services Limited, Mumbai (IN)

(72) Inventors: SOMA BANDYOPADHYAY, Kolkata (IN); ANISH DATTA, Kolkata (IN); CHIRABRATA BHAUMIK, Kolkata (IN); TAPAS CHAKRAVARTY, Kolkata (IN); ARPAN PAL, Kolkata (IN); RIDDHI PANSE, Bangalore (IN); MUDASSIR ALI SABIR, Bangalore (IN)

(73) Assignee: Tata Consultancy Services Limited, Mumbai (IN)

(21) Appl. No.: 18/465,046

(22) Filed: Sep. 11, 2023

(30) Foreign Application Priority Data
Oct. 27, 2022 (IN) 202221061234

(51) Int. Cl. G06N 3/0455

(52) U.S. Cl. CPC G06N 3/0455

(57) ABSTRACT

Synthetic data is an annotated information that computer simulations or algorithms generate as an alternative to real-world data. synthetic data is created in digital worlds rather than collected from or measured in the real world. Embodiments herein provide a method and system for generating synthetic data with domain adaptable features using a neural network. The system is configured to receive seed data from a source domain as an input data. The seed data is considered as a normal state of a machine. The normal state, which is an initial stage of the source domain, consists of a set of features with a certain range of values. Further, a neural network based model is used to generate high quality data with adaptation of the domain specific features. To obtain large amount data for training robust deep learning models to adapt domains emphasizing set of features/providing higher importance selectively.

### CROSS-REFERENCE TO RELATED APPLICATIONS AND PRIORITY

This U.S. patent application claims priority under 35 U.S.C. § 119 to Indian Application number 202221061234, filed on Oct. 27, 2022. The entire contents of the aforementioned application are incorporated herein by reference.

### TECHNICAL FIELD

The disclosure herein generally relates to the field of synthetic data generation and more specifically, to a method and system for generating synthetic data with domain adaptable features using a neural network.

### BACKGROUND

Synthetic data is an annotated information that computer simulations or algorithms generate as an alternative to real-world data. The synthetic data is created in digital world rather than collected from or measured in the real world. The synthetic data generation has been around in one form or another for decades.

Data synthesis for target domain using a small seed of source domain data is an important need because many a times getting the data (seed data) for the target domain is a challenge. However, there are possibilities to get a relation about the features of the source domain to the target domain, for example source domain is normal state and target domain is any of the fault progressed state where 4^{th} order moment or kurtosis increases by a certain known factor. Existing data generation models are not using domain adaptable features for a target domain. For example, a normal state of machinery data is easy to obtain however when the machine reaches to its final faulty state getting the data of intermediate faulty states representing different states/domains are difficult to obtain.

### SUMMARY

Embodiments of the disclosure present technological improvements as solutions to one or more of the above-mentioned technical problems recognized by the inventors in conventional systems. For example, in one embodiment, a method and system for generating synthetic data with domain adaptable features using a neural network is provided.

In one aspect, a processor-implemented method for generating synthetic data with domain adaptable features using a neural network is provided. The processor-implemented method comprising receiving a predefined amount of input data from a source domain, analyzing the received input data to determine one or more characteristics of a domain property with respect to the source domain and a target domain, and identifying variations of one or more domain adaptable features along with variation factors applied on the source domain to represent corresponding the one or more domain adaptable features in the target domain. Finally, an output data (i.e., synthetic data) is generated in the target domain based on the identified each of the one or more domain adaptable features using the neural network based model.

In another aspect, a system for generating synthetic data with domain adaptable features using neural network is provided. The system includes an input/output interface configured to receive a predefined amount of input data from a source domain, one or more hardware processors and at least one memory storing a plurality of instructions, wherein the one or more hardware processors are configured to execute the plurality of instructions stored in the at least one memory.

Further, the system is configured to analyze the received input data to determine one or more characteristics of a domain property with respect to the source domain and a target domain and identify variations of one or more domain adaptable features along with variation factors applied on the source domain to represent corresponding the one or more domain adaptable features in target domain based on the determined one or more characteristics of the domain property. Further, the system is configured to generate an output data in the target domain based on the identified each of the one or more domain adaptable features using a neural network based model.

In yet another aspect, one or more non-transitory machine-readable information storage mediums are provided comprising one or more instructions, which when executed by one or more hardware processors causes a method for generating synthetic data with domain adaptable features using neural network. The processor-implemented method comprising receiving a predefined amount of input data from a source domain, analyzing the received input data to determine one or more characteristics of a domain property with respect to the source domain and a target domain, and identifying variations of one or more domain adaptable features along with variation factors applied on the source domain to represent corresponding the one or more domain adaptable features in the target domain. Finally, an output data i.e., synthetic data is generated in the target domain based on the identified each of the one or more domain adaptable features using the neural network based model.

It is to be understood that the foregoing general descriptions and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates a block diagram of an exemplary system for generating synthetic data with domain adaptable features using a neural network, in accordance with some embodiments of the present disclosure.

FIG. 2 is a graphical representation to illustrate a trend of maximum peak amplitude (MPA) in frequency domain for original data and synthetic data, in accordance with some embodiments of the present disclosure.

FIG. 3 is a graphical representation to illustrate a trend of power spectral density for original data and synthetic data, in accordance with some embodiments of the present disclosure.

FIG. 4 is a graphical representation to illustrate a trend of relative change for original data and synthetic data, in accordance with some embodiments of the present disclosure.

FIG. 5 is a flow diagram to illustrate a method for generating synthetic data with domain adaptable features using neural network, in accordance with some embodiments of the present disclosure.

### DETAILED DESCRIPTION OF EMBODIMENTS

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

The embodiments herein provide a method and system for generating synthetic data with domain adaptable features using neural network. Herein, the neural network based model is used to generate high quality data with adaptation of the domain specific features.

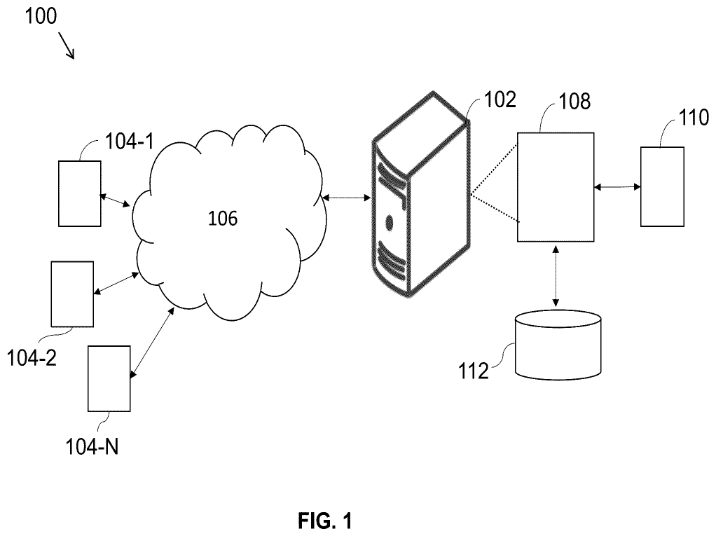

Referring now to the drawings, and more particularly to FIG. 1 through FIG. 5, where similar reference characters denote corresponding features consistently throughout the figures, there are shown preferred embodiments and these embodiments are described in the context of the following exemplary system and/or method.

FIG. 1 illustrates a block diagram of a system (100) for generating synthetic data with domain adaptable features using neural network, in accordance with an example embodiment. Although the present disclosure is explained considering that the system (100) is implemented on a server, it may be understood that the system (100) may comprise one or more computing devices (102), such as a laptop computer, a desktop computer, a notebook, a workstation, a cloud-based computing environment and the like. It will be understood that the system (100) may be accessed through one or more input/output interfaces 104-1, 104-2 . . . 104-N, collectively referred to as I/O interface (104). Examples of the I/O interface (104) may include, but are not limited to, a user interface, a portable computer, a personal digital assistant, a handheld device, a smartphone, a tablet computer, a workstation, and the like. The I/O interface (104) are communicatively coupled to the system (100) through a network (106).

In an embodiment, the network (106) may be a wireless or a wired network, or a combination thereof. In an example, the network (106) can be implemented as a computer network, as one of the different types of networks, such as virtual private network (VPN), intranet, local area network (LAN), wide area network (WAN), the internet, and such. The network (106) may either be a dedicated network or a shared network, which represents an association of the different types of networks that use a variety of protocols, for example, Hypertext Transfer Protocol (HTTP), Transmission Control Protocol/Internet Protocol (TCP/IP), and Wireless Application Protocol (WAP), to communicate with each other. Further, the network (106) may include a variety of network devices, including routers, bridges, servers, computing devices, storage devices. The network devices within the network (106) may interact with the system (100) through communication links.

The system (100) supports various connectivity options such as BLUETOOTH®, USB, ZigBee, and other cellular services. The network environment enables connection of various components of the system (100) using any communication link including Internet, WAN, MAN, and so on. In an exemplary embodiment, the system (100) is implemented to operate as a stand-alone device. In another embodiment, the system (100) may be implemented to work as a loosely coupled device to a smart computing environment. Further, the system (100) comprises at least one memory (110) with a plurality of instructions, one or more databases (112), and one or more hardware processors (108) which are communicatively coupled with the at least one memory (110) to execute a plurality of instructions. The components and functionalities of the system (100) are described further in detail.

In one embodiment, the one or more I/O interfaces (104) of the system (100) is configured to receive a predefined amount of seed data from a source domain as an input data. Herein the received input data is multivariate in nature. The predefined amount of seed data from a normal state of a predefined machinery is considered as an input data. Wherein the normal state, which is an initial stage of the source domain, consists of a set of features with a certain range of values. Whereas a target domain is a change of state defined by a set of context features. It can be considered as a fault progression state where the fault severity increases gradually. As an exemplary case, it can be considered as a fault progression state where the fault severity increases gradually.

In another embodiment, the system (100) is configured to analyze the received input data to determine one or more characteristics of a domain property with respect to the source domain and the target domain. The one or more characteristics of the domain property comprising a physics based property, a statistical property, and a probabilistic property.

In an example, in case of the predefined machinery reaches from normal to complete failure state, fault severity associating stiffness is a domain property. The system (100) measures change of stiffness impacting different statistical features like maximum amplitude of taking Fast Fourier Transform (FFT) of the machine vibration data.

In yet another embodiment, the system (100) is configured to identify a variation of one or more domain adaptable features along with variation factors applied on the source domain. The identified variation represents corresponding adapting features in target domain based on the determined one or more characteristics of a domain property. The one or more domain adaptable features includes maximum peak amplitude (MPA) of Fast Fourier Transform (FFT), a power spectral density derived on the FFT of the data, and moments based on difference signal like 4^{th} order Figure of Merit (FM4).

Every change in the target domain is associated with an adaptation of variation of the one or more domain adaptable features in the source domain. The variation of the one or more domain adaptable features is obtained by mapping the physics-based property of source domain with the probabilistic and statistical property of the source domain.

Further, the system (100) determines a ratio factor to express variation in at least one of one or more features of the target domain in comparison with the input domain. The ratio factor represents the variation of the features from the old state to a new state. The ratio factor is determined as an output of a domain knowledge extractor having an option of a trend analysis module of the system (100) relating to domain property & probabilistic property. The domain property is the contributor of cause and feature changes with ratio factor is the effect.

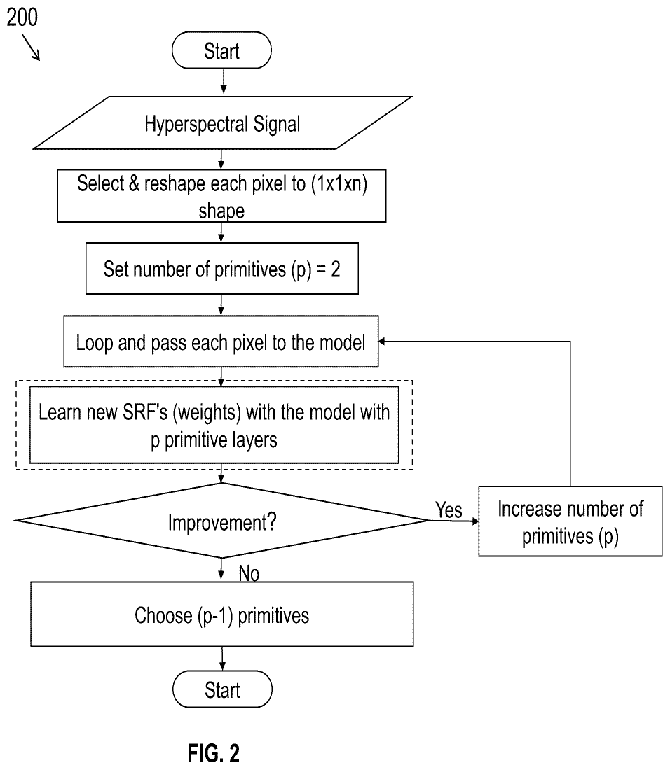

Referring FIG. 2, a graphical representation (200), establishing a trend curve based on statistical/probabilistic features on how the input data progresses from one state to a completely new state. For trend analysis, a maximum peak amplitude (MPA) in frequency domain is used as the feature to observe the trend of fault progression for original and the generated data. A trend is observed which is very similar for the generated data with respect to the original data.

In one instance, for the trend analysis of the cause effect mapping, the source domain, and the target domain are given as two final sets like normal and complete failure. A factor r to be defined which represents the variation of the feature from the old state to new state. For example, if feature F has value a in state A and value 2a in new state B, then the value of r will be 2.

In another embodiment, the system (100) is configured to generate an output data in the target domain based on the identified each of the one or more domain adaptable features using a neural network based model. The factor of adaptation is evaluated by a trend analyzer of the system (100). The trend analyzer of the system (100) does cause-effect mapping which maps the change of physical property and its impact into different statistical features. A generative learning using a regularized VAE (variational auto encoder) towards adaptable features is used.

The neural network based model taking predefined amount of source domain data as input, optimizes objective functions with one or more regularization to minimize loss or errors in terms of the one or more domain adaptable features. The loss function of the system (100) is defined as:

Loss=MSE_{Loss}(x,x′)+KLD_{Loss}+Σᵢ₌₁ⁿMSE(fᵢ*DAFᵢ(x),DAFᵢ(x′)) (1)

wherein, x is the input data, x′ is reconstructed data, MSE—mean square error loss, KLD_{Loss} is K-L divergence Loss, fᵢ is the factor of domain adaptable feature (DAFᵢ).

DAFᵢ=>FFT,FM4 (2)

wherein the reduction of Fast Fourier Transform (FFT) and FM4 with respect to source domain and generated target domain.

The neural network based model is a variational auto-encoder with a modified optimization function to adapt the one or more domain adaptable features to minimize the loss against the source domain data and generated the target domain data. The variational auto-encoder based generative model with customized regularization of the loss function generates the data by taking a predefined amount of data from source domain, adapts the characteristic given as cause-effect mapping or with a certain factor relating the source domain feature.

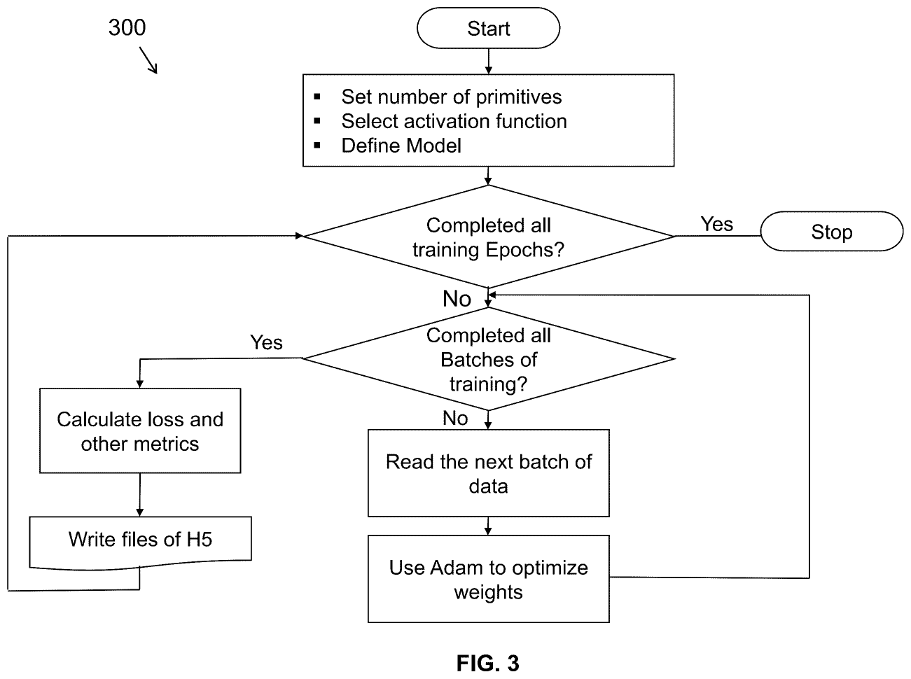

Referring FIG. 3, a graphical representation (300) to illustrate trend of power spectral density of Fast Fourier Transform (FFT) for original data and synthetic data, in accordance with some embodiments of the present disclosure. Wherein the normal state of machinery is an input domain and chipped tooth fault progressed to new states as an output domain. For initial experimentation, a feature is selected as a maximum peak amplitude (MPA) in frequency domain, power spectral density of FFT. Herein, an optimization is performed considering minimum number of features impacting multiple domain adaptable features.

It would be appreciated that the domain property gets modified when domain changes from the source domain to the target domain. For example, fault severity relates to stiffness which is a physical property. The domain property is mapped to different statistical, probabilities, signal property based features relating to corresponding changes in physical property like stiffness.

Furthermore, an objective function of the learning of neural model is modified such that minimum number of regularized features covers maximum number of domain adaptable features. Original and generated data of the MPA with the percentage variation of the generated intermediate chipped tooth fault state is shown below in table 1. The percentage variation of the MPA feature is 2.5-13.7% of the generated data with respect to the original data. The relationship of the feature of the generated data of different intermediate fault states resembles that of the original data.

TABLE 1

| | Factor | Maximum peak amplitude in | | |
|---|---|---|---|---|
| | taken | frequency domain (MPA) | | |
| | as input | Original | Generated | Percentage |
| Fault State | for MPA | data | data | variation |
| chip5a (0.15 mm) | 1.015 | 0.0179 | 0.0185 | 3.3% |
| chip4a (0.24 mm) | 1.2 | 0.0213 | 0.0226 | 6.1% |
| chip3a (0.38 mm) | 1.65 | 0.0290 | 0.0252 | 13.7% |
| chip2a (0.48 mm) | 1.14 | 0.0200 | 0.0195 | 2.5% |

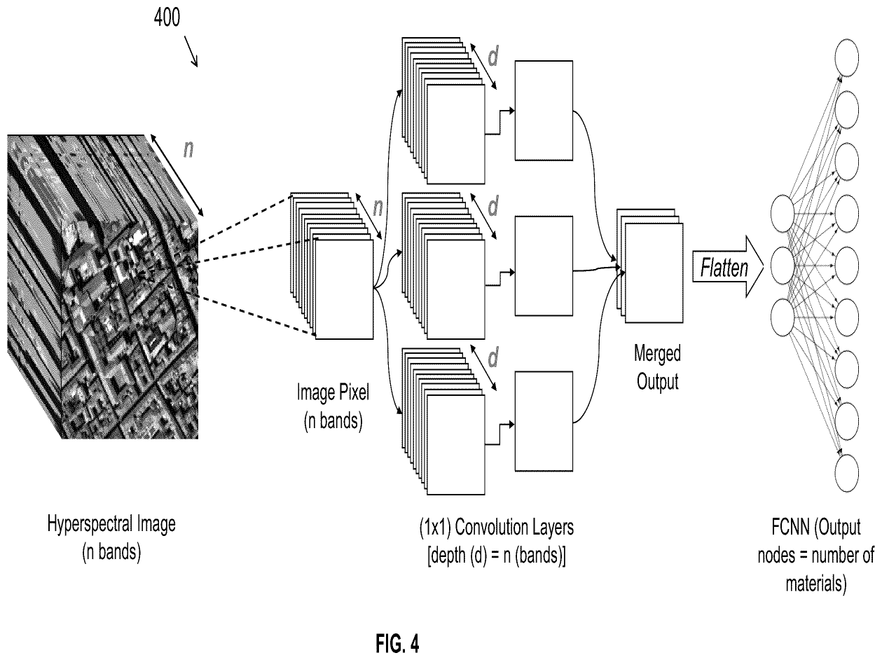

Referring FIG. 4, a graphical representation (400) to illustrate trend of relative change for original data and synthetic data, in accordance with some embodiments of the present disclosure. Wherein generating data for intermediate states taking FM4 as the domain adaptable feature completed for two states i.e., chip5a (0.15 mm) and chip4a (0.24 mm). Herein, the relative change of FM4 with respect to healthy data is plotted for the original and generated data. The trend of the feature in both states looks similar for the original and generated data.

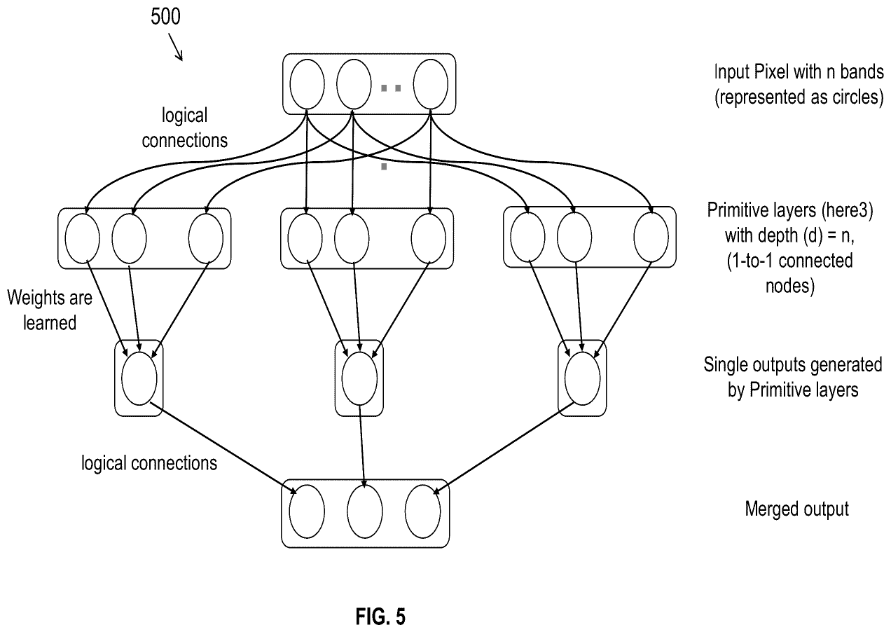

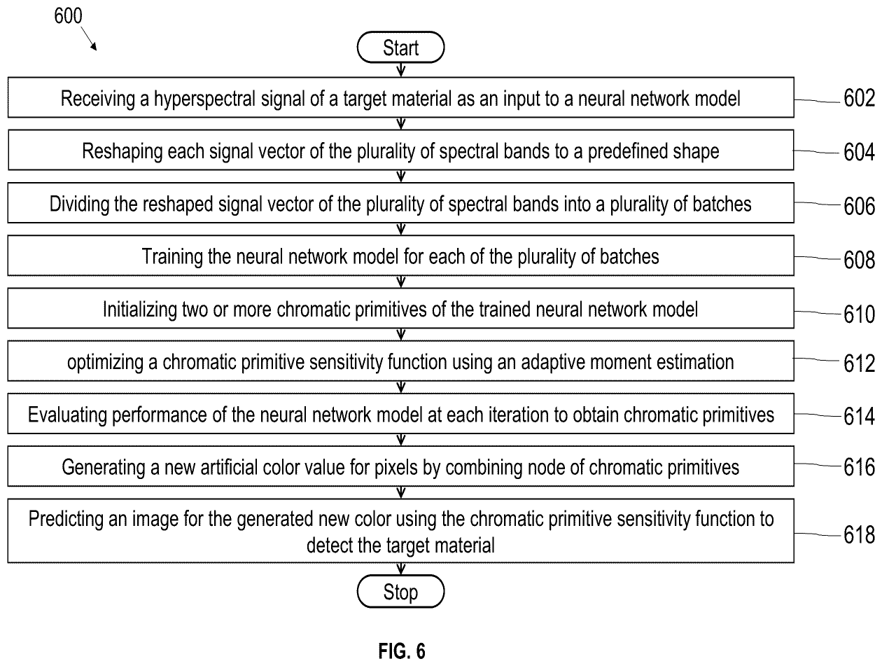

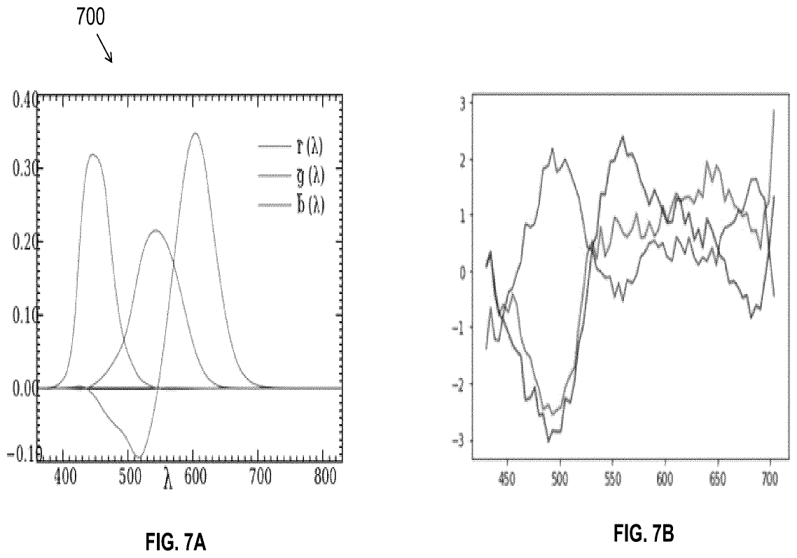

Referring FIG. 5, a flow diagram (500), to illustrate a processor-implemented method for generating synthetic data with domain adaptable features using a neural network, in accordance with some embodiments of the present disclosure. Initially, at step (502), receiving a predefined amount of input data from a source domain. Herein, the source domain is in a normal state.

At the next step (504), analyzing the received input data to determine one or more characteristics of a domain property with respect to the source domain and a target domain. The one or more characteristics of the domain property comprising a physics based property, a statistical property, and a probabilistic property.

At the next step (506), identifying a variation of the one or more domain adaptable features along with variation factors applied on the source domain to represent corresponding the one or more domain adaptable features in the target domain based on the determined one or more characteristics of the domain property. Wherein, every change in the target domain is associated with an adaptation of variation of the one or more domain adaptable features in the source domain. The variation of the one or more domain adaptable features is obtained by mapping the physics-based property of the source domain with the probabilistic property of the source domain.

At the last step (508), generating an output data in the target domain based on the identified each of the one or more domain adaptable features using a neural network based model. The neural network based model is a variational auto-encoder with a modified optimization function to adapt the one or more domain adaptable features to minimize the loss against input and generated output data. wherein the neural network based model taking predefined amount of source domain data as input optimizes objective functions with one or more regularization to minimize loss or errors in terms of the one or more domain adaptable features.

### Experiment:

Herein, for initial experimentation, the system chooses the feature as maximum peak amplitude (MPA) in frequency domain. Evidence obtained from University of Connecticut (UoC) gear fault dataset, as fault progresses the maximum peak amplitude (MPA) also increases. The generated data with adapted domain feature with peak amplitude 1.5 times as that of normal data (r=1.5).

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of present disclosure herein address the problem of synthetic data generation. The embodiments herein provide a method and system for generating synthetic data with domain adaptable features using a neural network. Herein, the neural network based model is used to generate high quality data with adaptation of the domain specific features.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software modules located therein. Thus, the means can include both hardware means, and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor-implemented method comprising:
receiving, via one or more input/output interface, a predefined amount of input data from a source domain, wherein the source domain is in a normal state;
analyzing, via one or more hardware processors, the received input data to determine one or more characteristics of a domain property with respect to the source domain and a target domain, wherein the one or more characteristics of the domain property comprises a physics based property, a statistical property, and a probabilistic property;
identifying, via the one or more hardware processors, a variation in each of the one or more domain adaptable features along with variation factors applied on the source domain to represent corresponding the one or more domain adaptable features in the target domain based on the determined one or more characteristics of the domain property; and
generating, via the one or more hardware processors, an output data in the target domain based on the identified variations in each of the one or more domain adaptable features using a neural network based model, wherein the output data reflects at least one change on the target domain.

2. The processor-implemented method of claim 1, wherein the at least one change in the target domain is associated with an adaptation of the identified variations of the one or more domain adaptable features in the source domain.

3. The processor-implemented method of claim 1, wherein the variation of the one or more domain adaptable features is obtained by mapping the physics-based property of the source domain with the statistical and probabilistic property of the source domain.

4. The processor-implemented method of claim 1, wherein the one or more domain adaptable features include a maximum peak amplitude of first Fourier transformation, a power spectral density derived on the first Fourier transform of the data, moments based on a difference signal.

5. The processor-implemented method of claim 1, wherein the neural network based model is a variational auto-encoder with a modified optimization function to adapt the one or more domain adaptable features to minimize the loss against input and generated output data for the target domain.

6. The processor-implemented method of claim 1, wherein the neural network based model taking predefined amount of source domain data as input optimizes objective functions with one or more regularization to minimize loss or errors in terms of the one or more domain adaptable features.

7. A system comprising:
an input/output interface to receive a predefined amount of input data from a source domain, wherein the source domain is in a normal state;
a memory in communication with the one or more hardware processors, wherein the one or more hardware processors are configured to execute programmed instructions stored in the memory to:
analyze the received input data to determine one or more characteristics of a domain property with respect to the source domain and a target domain, wherein the one or more characteristics of the domain property comprises a physics based property, a statistical property, and a probabilistic property;
identify a variation in each of the one or more domain adaptable features along with variation factors applied on the source domain to represent corresponding the one or more domain adaptable features in the target domain based on the determined one or more characteristics of the domain property; and
generate an output data in the target domain based on the identified variations in each of the one or more domain adaptable features using a neural network based model, wherein the output data reflects at least one change on the target domain.

8. The system of claim 7, wherein the at least one change in the target domain is associated with an adaptation of the identified variations of the one or more domain adaptable features in the source domain.

9. The system of claim 7, wherein the variation of the one or more domain adaptable features is obtained by mapping the physics-based property of the source domain with the probabilistic property of the source domain.

10. The system of claim 7, wherein the one or more domain adaptable features includes a maximum peak amplitude of first Fourier transformation, a power spectral density derived on the first Fourier transform of the data, moments based on a difference signal.

11. The system of claim 7, wherein the neural network based model is a variational auto-encoder with a modified optimization function to adapt the one or more domain adaptable features to minimize the loss against input and generated output data for the target domain.

12. The system of claim 7, wherein the neural network based model taking predefined amount of source domain data as input optimizes objective functions with one or more regularization to minimize loss or errors in terms of the one or more domain adaptable features.

13. One or more non-transitory machine-readable information storage mediums comprising one or more instructions which when executed by one or more hardware processors cause:
receiving, via one or more input/output interface, a predefined amount of input data from a source domain, wherein the source domain is in a normal state;
analyzing the received input data to determine one or more characteristics of a domain property with respect to the source domain and a target domain, wherein the one or more characteristics of the domain property comprising a physics based property, a statistical property, and a probabilistic property;
identifying a variation in each of the one or more domain adaptable features along with variation factors applied on the source domain to represent corresponding the one or more domain adaptable features in the target domain based on the determined one or more characteristics of the domain property; and
generating an output data in the target domain based on the identified variations in each of the one or more domain adaptable features using a neural network based model, wherein the output data reflects at least one change on the target domain.

14. The one or more non-transitory machine-readable information storage mediums of claim 13, wherein the at least one change in the target domain is associated with an adaptation of the identified variations of the one or more domain adaptable features in the source domain.

15. The one or more non-transitory machine-readable information storage mediums of claim 13, wherein the variation of the one or more domain adaptable features is obtained by mapping the physics-based property of the source domain with the probabilistic property of the source domain.

16. The one or more non-transitory machine-readable information storage mediums of claim 13, wherein the one or more domain adaptable features includes a maximum peak amplitude of first Fourier transformation, a power spectral density derived on the first Fourier transform of the data, moments based on a difference signal.

17. The one or more non-transitory machine-readable information storage mediums of claim 13, wherein the neural network based model is a variational auto-encoder with a modified optimization function to adapt the one or more domain adaptable features to minimize the loss against input and generated output data for the target domain.

18. The one or more non-transitory machine-readable information storage mediums of claim 13, wherein the neural network based model taking predefined amount of source domain data as input optimizes objective functions with one or more regularization to minimize loss or errors in terms of the one or more domain adaptable features.
